(19) United States
(12) Patent Application Publication
(10) Pub. No.: US 2002/0169618 A1
(43) Pub. Date: Nov. 14, 2002

(54) Providing help information in a speech dialog system

(75) Inventor: Rudolf Caspari, Eichenau (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/091,584

(22) Filed: Mar. 7, 2002

(30) Foreign Application Priority Data
Mar. 7, 2001 (DE) 10110977.6

(51) Int. Cl. G10L 21/00

(52) U.S. Cl. 704/275

(57) ABSTRACT

A user can procure an overview of the currently valid options at each juncture of the dialog by calling the context-sensitive help via the general question “what is possible?” or “help!”. The help information is generated by a language that serves for modeling the basic background application by virtue of the fact that the language includes help prompts belonging to the respective context. The system generates the respectively appropriate help from the help prompts and the context knowledge.

### CROSS REFERENCE TO RELATED APPLICATIONS

This application is based on and hereby claims priority to German Application No. 10110977.6 filed on Mar. 7, 2001, the contents of which are hereby incorporated by reference.

### BACKGROUND OF THE INVENTION

The invention relates to a method, a computer program, a data carrier and a device for providing help information for a user in a speech dialog system for operating a background application.

Applications or background applications such as, for example, a technical unit in consumer electronics, a telephone information service (railroad, flight, cinema, etc.), a computer-aided transaction system (home banking system, electronic goods ordering, etc.) are increasingly being operated via a speech dialog system as access system (user interface). Such speech dialog systems can be implemented in hardware, software or a combination thereof.

The use of speech recognizers is necessary so that a user can put his queries in natural spoken language. Speech recognition methods are disclosed, for example in U.S. Pat. No. 6,029,135, U.S. Pat. No. 5,732,388, DE 196 36 739 C1, DE 197 19 381 Cl and DE 199 56 747 C1. However, these frequently have a greatly restricted vocabulary.

The following problems therefore arise when operating by speech:

a) the user does not know what he may say, and

b) the user does not know the conceptual model on which the background application is based.

Erroneous recognitions by the speech recognizer easily occur in case a). If the system is accessed via written language, this disadvantage occurs only when the system attempts to interpret all the words of the input. However, access via spoken language offers a substantially more attractive user interface, and so the problem plays a large role in practice.

In case b), without prior study of an operating guide the user can use the system at best in a limited fashion. However, no operating guide need be available, for example when the user would like to obtain information via a speech dialog by telephone. Moreover, reading an operating guide is attended in any case by an increased outlay on the part of the user. This reduces, in particular, the acceptance in operating complex systems. Problem b) also arises when access is via written language.

Various help systems have therefore been developed for speech dialog systems.

IVR (Interactive Voice Response) systems offer context-sensitive help. They are designed as speech menus according to the following pattern:

“Say f(A) if you want A”, f(.) representing a function, for example one that outputs the numbers of a telephone keypad as values.

“Say f(B) if you want B.”

“Say f(Y) if you want Y.”

The user obtains an overview of his options in each situation. When one of the options is selected, the system changes to the next lower level, and again provides an overview there of the available options.

The disadvantage of IVR systems relates to the fact in that although they are acceptable for an unpracticed user, they do lead in any case to protracted and complicated dialogs, since the dialog initiative proceeds from the system in each case, and this is not acceptable for practiced users. The user interface is inflexible.

The Diane dialog machine has been developed as a consequence of the inefficiencies of the IVR systems (DE 196 15 693 C1). It permits a dialog with mixed initiative. Diane assumes that it is the user who initially has initiative. A practiced user can give a specific command or make a specific inquiry or help inquiry without the need for a prior protracted enumeration of his options. A direct access to all the system options is ensured in this way, including those help offers that are located at lower levels in IVR systems.

A dialog only becomes necessary when the initial utterance of the user is (i) incomplete or (ii) ambiguous, or (iii) contradicts the options of the background application. If one of the three cases occurs, Diane seizes the initiative and conducts an elucidatory dialog with the user in order to determine the desired intention of the user and to inquire about missing knowledge units.

Diane uses an abstract task model that is based on the following principles, which are also presupposed for the inclusion of a help system:

P1) the background application can be interpreted as a finite set of transactions T1, T2, . . . , Tn.

P2) Each transaction has a name and has a finite set (which can be also be empty) of information parameters I1, I2, . . . , Im. These parameters must be known to the system so that the transaction can be executed.

P3) Belonging to each parameter is a grammar that serves for acquiring the parameter in the dialog.

The user can name the desired transaction and the associated parameters in a sentence, or not. In the first case, the transaction can be carried out at once. In the second case, the still unknown parameters are acquired in the dialog.

If the initial utterance of the user cannot immediately determine a transaction, the system automatically carries out an elucidatory dialog for determining the desired action. The same holds for parameter inputs that are unclear or incomplete.

The following example may be considered as illustration: the background application realizes the following task model, having transactions and the parameters set forth in brackets:

train information (start location, destination, start time, departure date)

flight information (start location, destination, start time, departure date)

money transfer (amount of money, payee's account, payee's bank or bank code)

cash withdrawal (amount of money, account number, bank code, PIN)

stock buying (number, company, limit)

stock selling (number, company, limit)

transmitter reception (transmitter, start time, stop time)

receipt of broadcast transmission (broadcast transmission, date)

call (telephone number)

In the case of the Diane dialog system, the three principles lead to the following states, in which the system expects an input from the user:

state a): no transaction has yet been selected, and the transactions T1, T2, . . . , Ti are still possible.

State b): the system has selected a transaction and inquired about a parameter value from the user.

State c): the system has put a yes/no question.

The Diane dialog machine does not offer any context-sensitive help, however.

The VoiceXML language has recently been defined, the aim being to be able to use the telephone as a natural-language access option for background applications on the Internet.

VoiceXML permits natural-language navigation in documents that are made available over the Internet by a document server. Starting from a root document, the user can conduct a dialog in this document or jump to other documents by speech command. Dialogs can then run in each document reached in this way that are based on grammars defined in this document.

The VoiceXML language further offers a language construct for help. VoiceXML makes available help tags in the case of which the programmer can react at each juncture in the dialog to help inquiries from the user. However, this help is provided only as an option and not generally integrated in the operating model. It is integrated by the programmer in the code directly at the desired juncture. This means that the system cannot always answer the user's help inquiries. Moreover, there is no link between the help prompts and the grammars used in the dialog.

It is, moreover, a disadvantage of the VoiceXML language that it must be programmed by hand.

What are termed SpeechObjects have also been developed. These are reusable, encapsulated dialog parts. They use a grammar for parsing the user input, prompts for the output, and a sequence logic. They are used to construct more complex dialogs. A help can also be programmed by hand with the aid of such SpeechObjects. However, this requires a high outlay on programming.

### SUMMARY OF THE INVENTION

It is one possible object of the invention to create a help system that supports the user in operating a speech dialog system for operating a background application.

The object may be also achieved by a computer program with machine readable program code for carrying out the method . A computer program is understood in this case to mean that the computer program is a negotiable product in whatever form, for example in a machine readable fashion on paper, on a computer readable data carrier, distributed by a network, etc.

Moreover, the object may be achieved by a data carrier on which there is stored a computer program that executes the method after being loaded into the main memory.

The method and system are explained in detail below.

The first step for a background application which is modeled in accordance with the abovenamed principles P1, P2, P3, and a dialog system that knows the abovenamed states a), b), c) is to generate a flat context-sensitive help.

A help grammar is firstly defined. An extremely simple example of a help grammar, for example, has the speech dialog system understand, for example, the utterances “Help!”, “Please help me.” or “What can I do?”, such that the system answers with a prompt, that is to say with a statement. In general terms, a prompt is a response or an utterance of the system. The prompts of the system are triggered by a help inquiry on the initiative of the user.

A range of prompts are defined below which support the selection of transactions or the input of parameter values. Examples of the use of the prompts are given further below.

A transaction prompt is defined for each transaction. Examples of transaction prompts, that is to say of help statements (right-hand column) of the system in relation to the individual transactions (left-hand column) are:

| | |
|---|---|
| Train information | “Obtain an item of train information” |
| Flight information | “Obtain an item of flight information” |
| Money transfer | “Transfer money” |
| Cash withdrawal | “Withdraw cash” |
| Stock buying | “Buy stocks” |
| Stock selling | “Sell stocks” |
| Transmitter reception | “Receive a transmitter” |
| Receipt of broadcast | “Receive a broadcast transmission” |
| transmission | |
| Call | “Call someone up” |

The transactions prompts therefore have, for example, an object and an infinitive.

A global help prompt is defined, in addition. Examples of global help prompts are: “You can: . . . ”, “Say one of the following options: . . . ?”, followed in each case by the enumeration of all the options, expressed by the respective transaction prompts. The global help prompts therefore has a subject and a modal verb for example.

A complete sentence with subject, predicate and object, is generated from the global help prompt and the transaction prompts by joining them sequentially: “You can call someone up.” Here, the predicate is formed by combining the modal verb and infinitive.

It would also be conceivable to dispense with the global help prompt and to define the transaction prompts straightaway in the form of “You can call someone up.”

For each parameter of a transaction, a parameter prompt is defined, on the one hand, which is used by the system to inquire after missing values for parameters, for example “What is your departure location?”, or “Name the departure location.”

In addition, a help prompt is defined in relation to each parameter, specifically either a parameter help prompt or an option prompt. Which prompt is defined and selected is explained in detail further below.

All possible values are enumerated for the respective parameter by the option prompt. The parameter help prompt, on the other hand, specifies the form in which the user can input a value for the parameter, to remain in the example, for example: “Name a location in Germany as departure location.”

Examples of parameter prompts (right-hand column, first row in each case) and of parameter help prompts (right-hand column, second row in each case) in relation to the individual parameters (left-hand column) are:

| | |
|---|---|
| Start location | “What is your departure location?” |
| | “Name a location in Germany as departure location.” |
| Start time | “When you want to depart?” |
| | “Say the departure time, e.g. 17 hr 45.” |
| Amount of money | “What amount of money do you want to transfer?” |
| | “Name the amount to be transferred, e.g. 400 euros 60.” |
| Account number | “What is your account number?” or “Name your account number.” |
| | “Say your account number as a sequence of numerals.” |
| Transmitter | “Which television transmitter do you want to receive?” |
| | “Name the television transmitter that you want to receive.” |
| Date | “On which day is the transmission being broadcast?” |
| | “Name the date in the following format: e.g. 12 February.” |
| Number of stocks | “How many items?” |
| | “Name the number of stocks that you want to buy in the form of a |
| natural number, e.g. 500.” | |

Instead of the parameter help prompt, it is also possible to define the option prompt for the parameter input with the aid of which the parameter values possible for the respective parameter can be listed. The option prompt is, for example: “Say one of the following options: . . . ”. It is followed by a listing of all the options. An example of the use of the option prompt in the case of stock buying, when it is the company whose stocks are to be purchased that must be input as parameter is: “Say one of the following options: BASF, Siemens, Deutsche Bank, . . . ”. The options are generated from the grammar of the respective parameters (see below).

A yes/no help prompt is also defined. An example of a yes/no help prompt is: “Please answer the question “. . . ?” with ‘Yes’ or ‘No’.”, the last question being repeated.

A question prompt is additionally defined for elucidatory dialogs. This is, for example: “Do you want . . . ?” If it is supplemented by a transaction prompt, the result is a complete sentence with subject, predicate and object: “Do you want to obtain an item of train information?”

The use of the defined prompts is outlined below.

In response to an inquiry from the system to the user (for example “What would you like?” after the operation of switching on or starting, or “Please specify the parameters (of the selected transaction).”), the user can either speak a suitable command or request context-sensitive help. For this purpose, he utters one of the forms that is understood by the help grammar. When the user's utterance is acquired by the help grammar, the system—which is precisely in one of the states a), b) or c)—reacts as follows:

in state a):

if no transaction has yet been selected, the user can either select a transaction—in accordance with the grammar provided for the purpose—or inquire after help. If he inquires after help, and if the transactions T1, T2, . . . , Ti are still possible, the system reacts with the output: “(global help prompt): (transaction prompt of T1), (transaction prompt of T2), . . . , (transaction prompt of Ti).” The global help prompt “you can: . . . ” is supplemented by the list of the transaction prompts. In the state a) of the system, the user therefore hears, for example: “you can: obtain an item of train information, obtain and item of flight information, transfer money, withdraw cash, . . . ”.

Reacting to this, the user utters: “obtain an item of train information” or “train information” or any desired other, grammatically permissible transaction call. Equally, he can repeat the help call if his decision or his options are still not clear to him.

In an elucidatory dialog (in accordance with DE196 15 693 C1, see above) of the state a) of the system after an unclear input, the user hears, for example, the question: “(question prompt)+(transaction prompt)”, the transaction prompt of the transaction determined by the system as most likely being output. Thus, one example is: “do you want to obtain an item of train information?”. The user's answer to this is “Yes”/“Yes please”/“No”, or he utters the command: “Obtain an item of train information” or “Train information”, or any other desired, grammatically permissible transaction call. Equally, he can carry out a help call if his decision or his options are still not clear to him. In this case, all available transactions are enumerated using the scheme specified above. In one variant of the elucidatory dialog, the system points out other possible transactions after a short waiting time—if the user does not express himself.

If only very few transactions are available, instead of enumerating the options the system can also in each case conduct a yes/no dialog in the form “(question prompt)+(transaction prompt of Ti)” for each possible transaction: “Do you want to obtain an item of train information?”. The system waits for an answer after these questions. After a while without an answer, the system can propose the next transaction by a question.

A help call is answered in this situation by a yes/no help prompt.

So that the system does not output too many options in the form “(question prompt)+(transaction prompt of Ti)” one after another, subsequently waiting for an answer and thereby tiring the user, the number of options to be output one after another in this way is limited. A natural number D that is denoted as dialog threshold is defined for this purpose. A comparison of the number of options with D decides whether the available options in the form “(question prompt)+(transaction prompt of Ti)”, or whether all the options closed by the global help prompt (“say one of the following options: . . . ”) are output. Sensible values for D are 2 or 3, for example. The global help prompt is selected if more than 2 or 3 options are present.

In state b):

The user has selected a transaction of the system, for example buy stocks. The system now expects the user to input at least one parameter value. The user can say, for example: “I would like to buy 200 Siemens stocks.”, and in doing so has handed over two parameters to the system: the name of the company whose stocks are to be brought, and the number of the stocks to be brought.

Should the input of parameters be unclear, the system carries out an elucidatory dialog with the user (see DE 196 15 693 C1).

If the user does not express himself within a certain time, the system takes the initiative and asks for the parameter values from the user by the parameter prompts.

The user then speaks either the parameter value or the parameter values in the grammar defined for this transaction or these parameters, or he asks for a help to input the parameter value. There are two cases to be distinguished for generating the help prompt:

case a): the parameter grammar has the generating property, that is to say a list of all options for the parameter input is linked to the grammar, for example the list of all companies in the DAX. Thus, in the simplest case the grammar comprises, for example, the list “BASF, Siemens, Deutsche Bank, . . . ”. (The options can also be calculated automatically from the grammar, depending on the formalism used for the grammar). The system then utters the option prompt and lists all the options produced by the grammar. The result in the example of stock buying is, for example, the following dialog segment: (parameter prompt:) “In which company would you like to buy stocks?”, “Help!”, (option prompt:) “Say one of the following options: BASF, Siemens, Deutsche Bank, . . . ”.

Case b): the parameter grammar does not have the generating property, that is to say it is impossible in practice to list all the options for the required parameter value. An example of this is the time of day. The system then expresses the parameter help prompt, for example: “Say the departure time e.g. 17 hr 45.” By speaking, the user can now input the parameter value in the grammar in accordance with the examples given by the system. Otherwise, he repeats the help inquiry.

In state c):

The system has put a yes/no question and expects “Yes” or “No” as answer from the user. The user can request help if he has become disorientated. The system then expresses the yes/no help prompt while repeating the question. The user can then reply.

The principle of providing the user at each juncture of the dialog with data on the available options is known from the IVR systems. This principle is linked to a language that serves for modeling the basic background application by virtue of the fact that the language is expanded by help slots. The system then generates the help appropriate in each case from the help slots and the context knowledge.

It is possible in principle to distinguish between static and dynamic help systems. Static help systems (for example Microsoft Help for Word) give the user help relating to topics formulated by him. They can be used only if the user knows the conceptual model of the background system to some extent, since he must put a specific question. Static help can be requested in any situation and, depending on the situation, always supplies the same result if the inquiry does not change.

Dynamic help systems can exist independently of static help systems and simultaneously therewith. They support the user as a function of context in the respective situation during the running phase of a complex operating process (which is realized here via a speech dialog). It is characteristic here that the user does not put a specific question, but can use the general question “What is possible?” to procure an overview of the currently valid options. The user does not need to have a conceptual model of the task. However, he learns this by being conveyed the system options valid in the respective context via a global help command.

Dynamic help systems can be used only when, at any instant, the system itself has access to the complete knowledge that is required for operation, and this knowledge is also adequately structured.

The help mechanism generated by the system is uniform and therefore easy for the end user to understand. A global help command is easy to learn.

The dialog initiative is mixed in the case of the help system . The user can employ his knowledge of the system to accelerate the operation, and does not tire so quickly. Consequently, advantages arise both for the end user of the system and for the system developer.

Advantages for the system developer reside, in particular, in that the help system is generated automatically from the specifications as the system is being set up and does not need to be programmed separately. The system developer need only insert help prompts into prefabricated help slots. This requires only a minimal outlay.

Definition of grammars for inputs renders possible various speech inputs for a command. The system becomes flexible with regard to different modes of expression of different users.

As to navigation, if the user wishes to go back or has become completely disorientated, it is still possible to provide a command “go back!” which causes the system to change back from state c) to state b), or from state b) to state a).

The context-sensitive help described can also be hierarchically structured. This is particularly helpful in the case of systems with very many possible transactions.

Such a hierarchical structuring is performed by introducing substates. A substate has a name and includes a set of transactions and—optionally, of a set of further substates. A prompt and a grammar are defined, in turn, for each substate.

The following examples may be considered: the information substate includes train information and flight information transactions. The prompt for the information substate is: “obtain an item of information”. The grammar for the information substate, that is to say the possible linguistic forms for the input, is, for example: “Information”, or “Obtain information”.

The situation is similar for the financial transaction substate. It includes the stock-trading substate and the money transfer and cash withdrawal transactions. The prompt for the financial transaction substate is: “Carry out home banking”. The grammar for the financial transaction substate is, for example: “Home banking”.

The stock-trading substate includes the stock buying and stock selling transactions. The prompt for the stock-trading substate is: “Trade stocks”. The grammar for the stock-trading substrate is: “stock”.

The substates should be defined in this case such that each transaction occurs in at most one substate. Furthermore, the grammars are not to overlap, that is to say a grammar is to point to only one substate, since otherwise there is no unique assignment between user utterance and substate.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a set of 21 actions;

FIG. 2 shows a breakdown of the set in accordance with FIG. 1 in 6 substates of level 1;

FIG. 3 shows a breakdown of the set in accordance with FIG. 1 into substates of level 1 and substates of level 2; and

FIG. 4 shows a breakdown of the set in accordance with FIG. 1 into substates of levels 1, 2 and 3.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Stage 0:

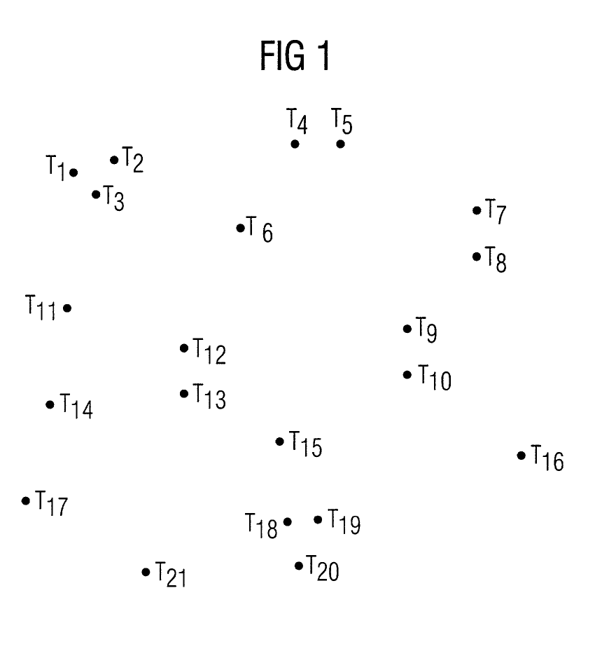

An application A with the transactions T1, . . . , Tm may firstly be considered (FIG. 1).

This application is divided below in a successively hierarchical fashion, higher division planes being formed step by step starting from the lowermost stage 0.

Stage 1: generation of substates of level 1:

If A11 is a subset of A with at least 2 elements, S11:=A11 defines a substate of level 1. If A12 is subset of A\A11 with at least 2 elements, “\” standing for the exclusion operation “without”, S12:=A12 defines a further substate of level 1.

If A1k is a subset of A\A11\A12\ . . \Alk-1 with at least 2 elements, S1k:=A1k defines a further substate of level 1, k being a natural number.

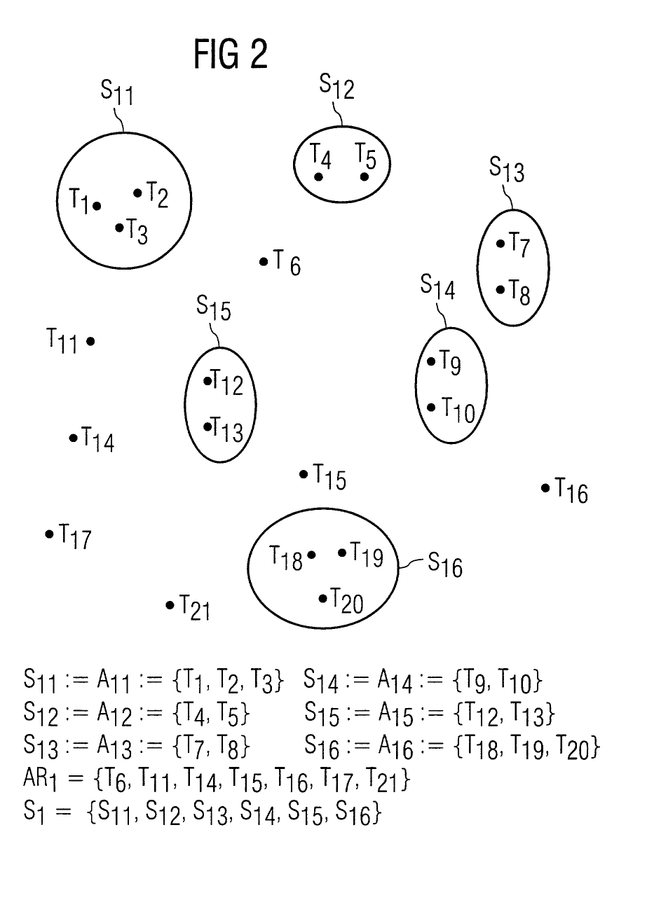

The overall application therefore falls into a number of substates of level 1 and into transactions that do not occur in any substate. (see FIG. 2), because it holds in accordance with the construction A=S11 U S12 U . . . U S1k A\A11\A12\ . . A1k-1\Alk, “U” standing for the union of two sets. We now define the remainder action set of stage 1 by AR1:=A\A11\A12\ . . A1k-1\Alk, and the substate set of stage 1 by Si:=(S11, S12, . . . , S1k).

The introduction of substates has now yielded a view of the set A in which it can be regarded as including fewer members, since each substate is now interpreted as only one member.

Stage 2: generation of substates of level 2:

If A21 is a subset of AR1 and sub21 is subset of the substate set S1 formed in stage 1, S21:=sub21 U A21 defines a substate of level 2 when this union includes at least 2 elements.

If A22 is a subset of AR1\A21 and sub22 is a subset of S1\sub21, a substate of level 2 is defined by S22:=sub22 U A22 when this union includes at least 2 elements.

If A21 is a subset of AR1\A21\A22 . . . A21-1 and sub21 is a subset of S1\sub21\sub22\ . .\sub21-1, S21:=sub21 U A21 defines a substate of level 2, 1 being a number, when this union includes at least 2 elements.

We now define AR2:=AR1\A21\A22\ . . \A21-1\A21 as the remainder action set of stage 2: SubR1:=S1\sub21\sub22\ . . \sub21-1\sub21 as the remainder substate set of stage 1, and S2:={S21, S22, . . . , S21) the substate set of stage 2.

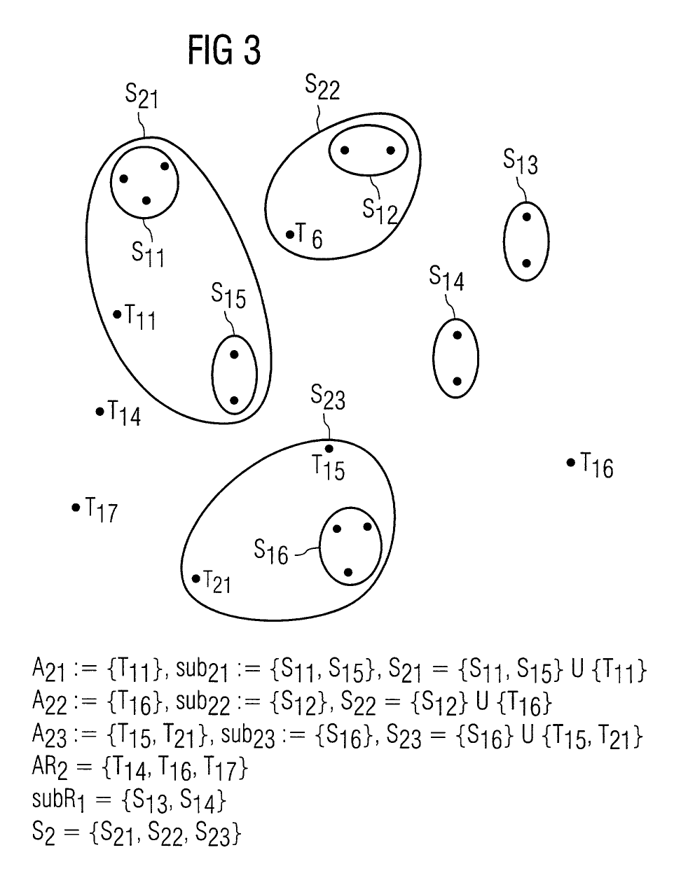

The overall application now falls into a certain number of substates of level 2, a certain number of substates of level 1 and a remainder set of actions that do not belong to any substate (see FIG. 3).

By contrast with the breakdown of A constructed in stage 1, the breakdown formed in stage 2 has the advantage that it is courser in the sense that it includes still fewer elements than that formed in stage 1, since a substate of level 2 is now interpreted only as one member.

Stage m: generation of substates of level m:

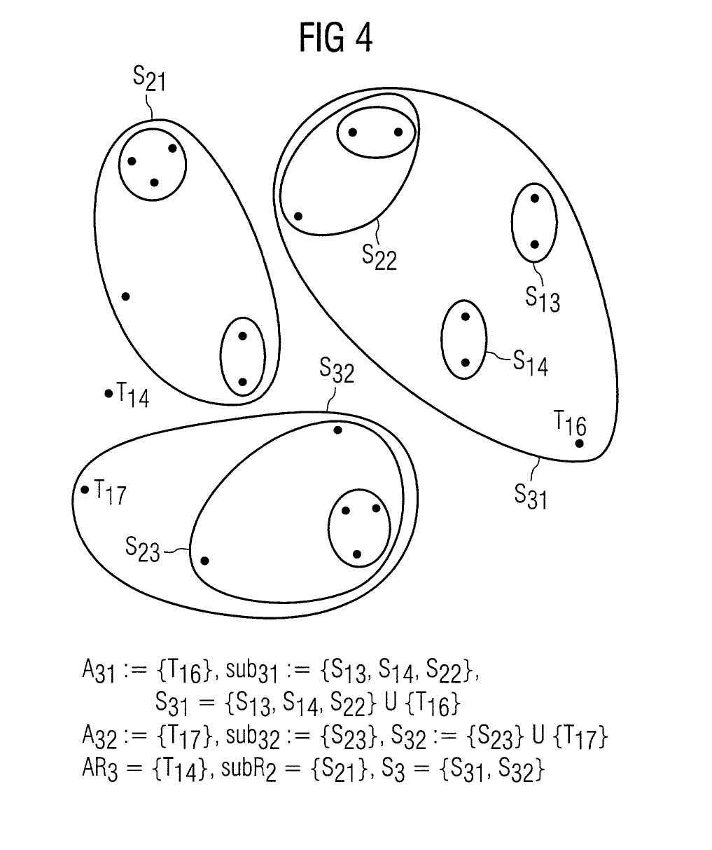

The method is continued iteratively. If substates of levels up to m-1 have already been generated and remainder sets of unused actions and unused substates of levels 1 to m-2 have been obtained in the process, new substates of level m can be formed by combining substates of levels m-1 and unused substates of levels m-2, m-3, . . . , 1 and remaining actions, the remainder sets of actions and substates of levels 1, 2, . . . , m-1 being appropriately diminished in the case of each such formation. At least 2 elements must always be combined, since the number of elements is to be reduced in the case of each combination (see FIG. 4 for m=3).

The method can be ended at will after each level, and ceases to make sense anymore at the latest when the division is so coarse that only 2 more elements have been left over.

The imposition of a hierarchical structure replaces the previous state a) by the new state d), which is then: “The system is in a substate”.

In state d):

The system is in a substate of level n. The start state of the system is defined as substate of level m, m being the largest natural number for which a substate was still formed. m=3, for example, in FIG. 4.

Two questions now need to be answered:

Question 1: how does the system behave upon a help request when situation d) exists?

Answer:

Let the system be in a substate of level n. This may include the substates S1n-1, . . . , Sk(n-1)n-1 of level n-1, the substates S1n-2, . . . , Sk(n-2)n-2 of level n-2, . . . , the substates S11, . . . , Sk(1)1 of level 1, and individual transactions T1, . . . , Tk(O). In this case, k(.) is a function that determines in relation to each number which denotes the level the number of substates belonging to this level number.

The system then utters:

“(global help prompt):

(prompt of S1n-1),

. . . ,

(prompt of Sk(n-1)n-1),

(prompt of S1n-2),

. . . ,

(prompt of Sk(n-2)n-2),

(prompt of S11),

. . . ,

(prompt of Sk(1)1),

(prompt of T1),

. . . ,

(prompt of Tk(O))”

Question 2: How does the system pass into a substate, and which system response characterizes the substate?

The first comes about by the user making at the level in which the substate is defined an utterance that is analyzed by the grammar and understood as selection of the substate.

If m is the largest natural number for which a substate has been formed (E.g. m=3 in FIG. 4), the initial state of the system of substates includes up to at most level m and remaining actions. If the utterance of the user is now analyzed by the grammar of a substate of level n<m, the system jumps over into the latter.

The system response of the substate then reached, or of its elements is characterized in that no transaction has yet been selected, but now only the transactions contained in the substate directly or in a substate situated therebelow are available.

If a substate is reached through a user utterance, then depending on the value of the abovementioned dialog threshold D the system utters the available substates and transactions according to the abovedescribed pattern, that is to say either in the form of “(global help prompt)” followed by the enumeration of the transaction prompts, or by “(question prompt)+(transaction prompt of Ti)”.

The method of imposing substates resembles the mode of procedure of IVR systems but, differing from them, direct access is possible over a plurality of intermediate levels. All the original options of the system up to direct specification of a transaction with its parameters are maintained. Structuring by substates constitutes only a provision of help for unpracticed users.

The advantages for the user reside, in particular, in that the background application gains in self-descriptiveness by the hierarchical structuring subsequently introduced into the original flat structure. This renders operation without an operating guide more readily possible.

For unpracticed users, an advantage arises that the system can respond locally like an IVR system to an explicit request. The user's options for direct access are maintained, however. This produces systems that can be operated effectively in like manner by practiced and unpracticed users.

For navigation purposes, it is possible again to provide the command “Go back”, which causes the system to change back from state c) to state b), or from state b) to state d), in the case of which the system is in a substate, or inside the state d) from one level to a higher level.

Context-sensitive help according to the above description is implemented for the Diane dialog machine. If the abovedescribed background application is used as concrete application, the following dialogs could be conducted (if a dialog threshold of D=2 is defined):

Dialog 1: (shows the stepwise rise in the hierarchy. The unpracticed user navigates
only using the help command, or utters one of the options offered by the system)

| | |
|---|---|
| System: | What can I do for you? |
| User: | Help! |
| System: | You can obtain an item of information, carry out home banking, receive a |

transmitter, receive a broadcast transmission, call someone up.

| | |
|---|---|
| User: | Home banking. |
| System: | You can trade stocks, transfer money, withdraw cash. |
| User: | Trade stocks. |
| System: | Would you like to buy stocks? |
| User: | No. |
| System: | Would you like to sell stocks? |
| User: | Yes. |
| System: | How many items? |

Dialog 2: (shows the direct access. The practiced user knows the options of the
system and can express himself directly)

| | |
|---|---|
| System: | What can I do for you? |
| User: | I would like to buy stocks. |
| System: | How many items? |

Dialog 3: (knows the jump to a substate)

| | |
|---|---|
| System: | What can I do for you? |
| User: | I would like to conduct home banking. |
| System: | You can trade stocks, transfer money, withdraw cash. |
| User: | I would like to buy 200 Siemens stocks. |
| System: | To what limit? |

Dialog 4: (shows the parameter help when the parameter grammar does not have
the generating properly.)

| | |
|---|---|
| System: | What can I do for you? |
| User: | I would like to buy 200 Siemens stocks. |
| System: | To what limit? |
| User: | Help! |
| System: | Say the amount of money in euros. |

Dialog 5: (shows the parameter help when the parameter grammar has the
generating properly).

| | |
|---|---|
| System: | What can I do for you? |
| User: | I would like to buy stocks. |
| System: | How many items? |
| User: | 100. |
| System: | In which company? |
| User: | Help! |
| System: | Say one of the following options: Adidas, BASF, Bayer, Commerzbank, |

Deutsche Bank, Dresdner Bank, Epcos, . . . (lists all options).

The invention has been described in detail with particular reference to preferred embodiments thereof and examples, but it will be understood that variations and modifications can be effected within the spirit and scope of the invention.

What is claimed is:

1. A method for providing help information for a user in a speech dialog system for operating a background application, the background application being modeled on principles P1 through P3:
P1) the background application can be interpreted as a finite set of transactions T1, T2, . . . , Tn;
P2) each transaction has a finite set of parameters required to execute the transaction;
P3) each parameter has a grammar that serves to acquire a value for the parameter in a speech dialog;
the speech dialog system can assume at least the following states:
state a): no transaction has yet been selected, and the transactions T1, T2, . . . , Ti are still possible;
state b): a transaction has been selected, but not all parameter values relating to this transaction have yet been input;
the method comprising:
storing a transaction prompt for each transaction;
storing a help prompt for each parameter;
a global help command to request help; and
outputting a prompt corresponding to the state and context after detection of the global help command such that
at least one transaction prompt is output in the state a); and
at least one help prompt is output in the state b).

2. The method as claimed in claim 1, wherein the help prompt stored for each parameter either enumerates all possible values of this parameter or specifies the form in which a value for the parameter is to be input.

3. The method as claimed in claim 1, wherein after detection of the global help command in state a)
either all possible transactions are output to with a global help prompt,
or, by a question containing a transaction prompt, to be answered with “yes” or “no”, the user is asked individually for each available transaction whether he wishes to execute this transaction .

4. The method as claimed in claim 1, wherein
a global help prompt is stored; and
after uttering the global help command, a user is provided with possible options for state a) by a combination of the global help prompt and the transaction prompt.

5. The method as claimed in claim 1, wherein an option prompt is stored and output with all values that are possible for a respective parameter.

6. The method as claimed in claim 1, wherein a grammar is stored for each possible user input.

7. The method as claimed in claim 1, wherein the available transactions are hierarchically ordered.

8. The method as claimed in claim 2, wherein after detection of the global help command in state a)
either all possible transactions are output to with a global help prompt,
or, by a question containing a transaction prompt, to be answered with “yes” or “no”, the user is asked individually for each available transaction whether he wishes to execute this transaction.

9. The method as claimed in claim 8, wherein
a global help prompt is stored; and
after uttering the global help command, a user is provided with possible options for state a) by a combination of the global help prompt and the transaction prompt.

10. The method as claimed in claim 9, wherein an option prompt is stored and output with all values that are possible for a respective parameter.

11. The method as claimed in claim 10, wherein a grammar is stored for each possible user input.

12. The method as claimed in claim 11, wherein the available transactions are hierarchically ordered.

13. A system for providing help information for a user in a speech dialog system for operating a background application, the background application being modeled on principles P1 through P3:
P1) the background application can be interpreted as a finite set of transactions T1, T2, . . . , Tn;
P2) each transaction has a finite set of parameters required to execute the transaction;
P3) each parameter has a grammar that serves to detect a value for the parameter in a speech dialog;
the speech dialog system can assume at least the following states:
state a): no transaction has yet been selected, and the transactions T1, T2, . . . , Ti are still possible;
state b): a transaction has been selected, but not all parameter values relating to this transaction have yet been input;
the system comprising:
a memory to store a transaction prompt for each transaction and a help prompt for each parameter;
a detection unit to detect a global help command;
an output unit to output a prompt corresponding to the state and context, after detection of the global help command such that
at least one transaction prompt is output in the state a); and
at least one help prompt is output in the state b).

14. A method for providing help information to a user of a voice operated system that executes one of a plurality of transactions after the transaction has been identified and a value for each parameter associated with the transaction has been entered, comprising:
receiving an oral command requesting help;
matching the oral command with a stored global help command;
outputting at least one transaction prompt if the user has not identified the transaction; and
outputting at least one parameter help prompt if the user has identified the transaction, but has not entered a value for each parameter associated with the transaction.

15. The method as claimed in clam 14 wherein
there are numerous possible transactions,
the possible transactions are separated into groups,
the user is prompted to select a group of transactions, and
after the user selects a group of transactions, the user is prompted to select a transactions within the group of transaction.
